(19) United States
(12) Patent Application Publication
(10) Pub. No.: US 2026/0229919 A1
(43) Pub. Date: Aug. 6, 2026

(54) WIRELESS POWER AND DATA PROVISIONING IN LEVER CONTROL SYSTEMS FOR MARINE VESSELS

(71) Applicant: VOLVO PENTA CORPORATION, Göteborg (SE)

(72) Inventors: Mikael NYSTRÖM, Lindome (SE); Peter SILJEHOV, Ulricehamn (SE)

(73) Assignee: VOLVO PENTA CORPORATION, Göteborg (SE)

(21) Appl. No.: 19/444,876

(22) Filed: Jan. 9, 2026

(30) Foreign Application Priority Data
Jan. 31, 2025 (EP) 25155201.4

(51) Int. Cl. H02J 50/10; H02J 50/00; H04B 5/26; H04B 5/79

(52) U.S. Cl. CPC H02J 50/10; H02J 50/005; H04B 5/266; H04B 5/79

(57) ABSTRACT

A lever control system for a marine vessel, has a base module with a first wireless communication unit; and a lever module connected to the base module and rotationally movable with respect to the base module. The lever module has a second wireless communication unit. The first and second wireless communication units are configured for bidirectional data communication, and the first wireless communication unit is configured to supply power to the lever module via the second wireless communication unit.

### TECHNICAL FIELD

The disclosure relates generally to lever control systems for marine vessels. In particular aspects, the disclosure relates to wireless power and data provisioning in lever control systems for marine vessels. The disclosure can be applied to marine vessels, such as leisure boats, ships, cruise ships, fishing vessels, yachts, ferries, among other vehicle types. Although the disclosure may be described with respect to a particular marine vessel, the disclosure is not restricted to any particular marine vessel.

### BACKGROUND

In marine vessels, lever control systems are used for managing operations such as throttle control. Current lever control systems often fail to meet the necessary standards of reliability, ease of maintenance, and adaptability to harsh marine environments due to issues such as corrosion from saltwater exposure, mechanical wear from constant use, and insufficient resilience to temperature extremes. These limitations can lead to system failures, costly repairs, and unsafe operating conditions, emphasizing the need for improved designs.

### SUMMARY

A drawback of existing solutions is their reliance on wired connections for communication and power supply. These wired systems are prone to water ingress, undermining reliability and performance. The need for complex disassembly not only increases maintenance expenses but also extends the time vessel remains out of operation.

Given these challenges, there is a need for an improved lever control system. Such a system should simplify maintenance, enhance reliability, and reduce the risk of water ingress or mechanical failure, while maintaining or improving the operational capabilities of the marine vessel. The present inventors have therefore identified that wireless solutions are particularly desirable for their potential to address these issues effectively.

In a first aspect of the disclosure there is accordingly provided a lever control system for a marine vessel, comprising a base module comprising a first wireless communication unit; and a lever module connected to the base module and rotationally movable with respect to the base module, the lever module comprising a second wireless communication unit, wherein the first and second wireless communication units are configured for bidirectional data communication, and wherein the first wireless communication unit is configured to supply power to the lever module (30) via the second wireless communication unit.

The first aspect of the disclosure may seek to improve reliability and ease of maintenance. A technical benefit may include enhanced system durability and reduced maintenance costs due to the wireless configuration.

Optionally in some examples, including in at least one preferred example, the wireless communication units comprise coils configured for radio frequency, RF, communication and power transfer. A technical benefit may include an enhanced system efficiency by combining data and power transfer.

Optionally in some examples, including in at least one preferred example, wherein the coils are arranged at select portions of the base module and the lever module, respectively, such that their respective axes align to allow intersection of generated magnetic fields in response to electrical current flow. A technical benefit may include an improved magnetic field interaction, improving signal quality and power transfer.

Optionally in some examples, including in at least one preferred example, wherein the coils are aligned in a circular pattern. A technical benefit may include a uniform magnetic field distribution, enhancing consistency in communication.

Optionally in some examples, including in at least one preferred example, wherein the coils are aligned in a squared pattern. A technical benefit may include a directional focus in the magnetic field, potentially increasing coupling efficiency.

Optionally in some examples, including in at least one preferred example, wherein the coils are aligned in a tube-like pattern. A technical benefit may include consistent coupling over relatively longer distances.

Optionally in some examples, including in at least one preferred example, wherein the coils are aligned in a cone-like pattern. A technical benefit may include a directed magnetic field in tapered spaces, improving spatial adaptability.

Optionally in some examples, including in at least one preferred example, wherein the coils are integrated onto a circuit board. A technical benefit may include a compact design and robust protection against environmental factors

Optionally in some examples, including in at least one preferred example, wherein the coils comprise Litz wires. A technical benefit may include a reduced energy loss due to skin effect, enhancing high-frequency performance.

Optionally in some examples, including in at least one preferred example, wherein the coils comprise discrete wires including one or more strands. A technical benefit may include flexibility in coil design and configuration.

Optionally in some examples, including in at least one preferred example, the RF communication being based on a Near Field Communication (NFC) protocol. A technical benefit may include secure, short-range communication suitable for precise control tasks involving both energy and data transfer.

Optionally in some examples, including in at least one preferred example, wherein the lever module is removably attached to a rotatable portion of the base module. A technical benefit may include easy maintenance and part replacement.

Optionally in some examples, including in at least one preferred example, further comprising processing circuitry, the base module being operatively connected to the processing circuitry. A technical benefit may include improved data processing and control capabilities.

Optionally in some examples, including in at least one preferred example, wherein the lever module includes one or more control buttons, wherein an activation of a control button causes the second communication unit to wirelessly communicate data to the processing circuitry via the first communication unit. A technical benefit may include an enhanced operational flexibility and responsiveness.

Optionally in some examples, including in at least one preferred example, wherein the base module is configured to, in response to a signal from the processing circuitry, send a light indicator request to the lever module via the wireless communication units. A technical benefit may include providing visual feedback, improving user awareness and system interaction.

The disclosed aspects, examples (including any preferred examples), and/or accompanying claims may be suitably combined with each other as would be apparent to

anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an example marine vessel comprising an exemplary lever control system.

FIG. 2 is an example lever control system.

FIG. 3 is an example squared coil arrangement for an exemplary lever control system.

FIG. 4 is an example circular coil arrangement for an exemplary lever control system

### DETAILED DESCRIPTION

The detailed description set forth below provides information and examples of the disclosed technology with sufficient detail to enable those skilled in the art to practice the disclosure.

The present disclosure seeks to address one or more of the deficiencies of the prior art mentioned above by way of providing a lever control system that utilizes wireless communication units to eliminate wired connections. This solution prevents water ingress and enhances reliability, simplifying maintenance and allowing for easy part replacement without destructive disassembly. Compared to traditional systems involving physical electrical wires, this wireless solution offers a robust and efficient alternative, which is important for improving the operational performance of modern marine vessels.

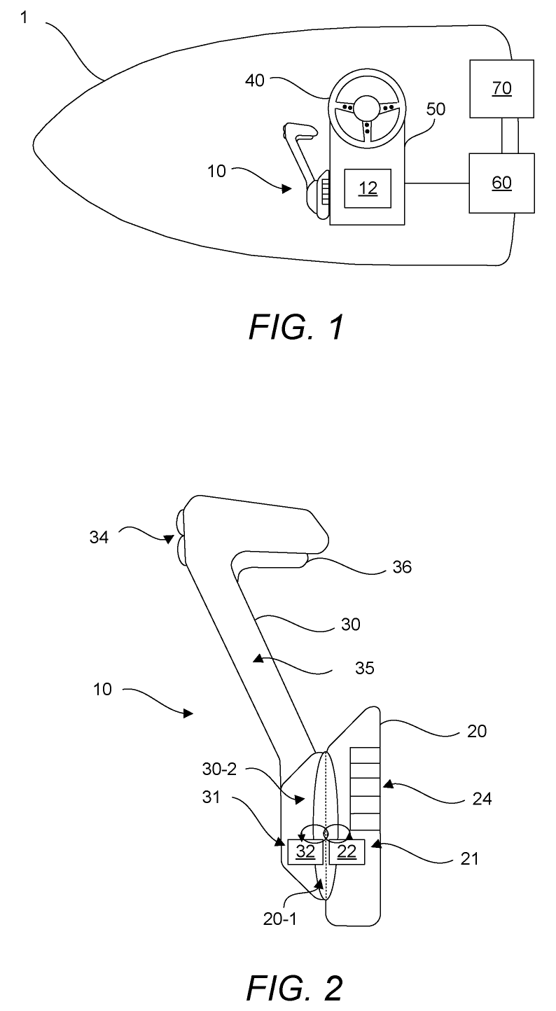

FIG. 1 shows an example marine vessel 1 having a lever control system 10. In non-limiting examples, the marine vessel 1 is a leisure boat, ship, cruise ship, fishing vessel, yacht, ferry, or the like. The marine vessel 1 is adapted to operate at bodies of water, e.g., a sea, ocean, lake, river, bay, gulf, strait, channel, reservoir, fjord, marsh, swamp, etc. The marine vessel 1 is propelled by a propulsion system 70, which may be one configured for an electric marine vessel, gasoline-powered marine vessel, diesel-powered marine vessel, a hybrid thereof, or the like, provided it can be controlled based on computer control via input signals from the lever control system 10.

The lever control system 10 is responsible for managing operations of the marine vessel 1. The lever control system 10 controls propulsion and maneuvering capabilities by regulating elements like engine power and propeller speed. The lever control system 10 receives user inputs, and integrates these with mechanical and electronic systems to translate commands into actions that drive the marine vessel 1 forward, backward, or perform some other auxiliary action such as sending control signals via control buttons.

The lever control system 10 interfaces with or comprises processing circuitry 12 of a helm station 50, which is configured to process inputs and commands, coordinating functions of the lever control system 10. The helm station 50 serves as the central control area where the operator manages navigation and propulsion. The processing circuitry 12 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 12 may further include computer executable code that controls operation of the programmable device.

The marine vessel 1 further includes a steering wheel 40, located at the helm station 50, which allows the operator to control the direction of the marine vessel 1.

Based on received control signals from the lever control signals 10 and/or the steering wheel 40, the helm station 50 causes control of the thrust and steering of the propulsion system 70, typically via a steering system 60.

FIG. 2 shows an exemplary lever control system 10 in more detail. The lever control system 10 includes two separate modules: one base module 20 and one lever module 30. These modules 20, 30 are designed to interact such that the lever module 30 can rotate relative to the base module 20, enabling control over various vessel operations.

The base module 20 serves as a stable foundation, ensuring the necessary support and stability for movements of the lever module 30. The base module 20 integrates with the helm station 50. The base module 20 might be mounted to the helm station 50 using for example brackets or fasteners. The base module 20 may be wiredly connected to a main battery of the vessel 1, ensuring a continuous power supply from the vessel’s 1 primary electrical system.

The lever module 30 is designed for throttle control, utilizing pitch motion to adjust the vessel’s 1 speed and thrust. A shaft 35 of the lever module 30 facilitates up-and-down movement around a horizontal axis that extends from port to starboard, allowing the operator to precisely modulate throttle settings. This motion directly influences the propulsion system 70, providing control signals for acceleration and deceleration.

Each one of the base module 20 and the lever module 30 comprises a wireless communication unit. These units are herein referred to as a first wireless communication unit 22, comprised in the base module 20, and a second wireless communication unit 32, comprised in the lever module 30. The wireless communication units 22, 32 are configured for two different purposes, namely for bidirectional data communication and for enabling power transfer from the base module 20 to the lever module 30. Hence, there is no longer any need for having wired connections between the base and lever modules 20, 30 thanks to the provisioning of these wireless communication units 22, 32.

Advantageously, the wireless communication units 22, 32 enables the lever module 30 to be removably attached to the base module 20. This removable attachment may be in between the lever module 30 and a rotatable portion 20-1 of the base module 20. The rotatable portion 20-1 refers to a segment that allows the lever module 30 to pivot or rotate, enabling control adjustments. The rotatable portion 20-1 thus serves as the connection point for the lever module 30, facilitating its movement. The removable attachment may include one or more fasteners such as screws, clamps, snap-fit connectors, or magnetic couplings.

In some examples, the wireless communication units 22, 32 comprise coils configured for radio frequency, RF, communication and power transfer. Hence, these coils serve to provide a solution to both of the above-mentioned purposes being bidirectional communication and power transfer. This may be carried out based on a Near-Field Communication (NFC) protocol, relying on the principle of electromagnetic induction.

The coils are arranged in close proximity to each other – usually within a few centimeters – to facilitate efficient energy transfer. For example, the coils can be arranged at select portion 21, 31 of the base module 20 and the lever module 30, respectively, such that their respective axes align to allow intersection of generated magnetic fields. An alternating current (AC) signal is applied to a transmitter coil, in this case being the first wireless communication unit 22 (in the example where NFC is used). The AC signal generates an oscillating magnetic field that extends outward from the transmitter coil. When this time-varying magnetic field encounters a receiver coil, being the other coil, it induces a voltage within that coil according to Faraday’s law of electromagnetic induction.

To transmit data, the applied AC signal is modulated. This involves altering characteristics of the carrier wave – such as its amplitude, frequency, or phase – to encode the information to be sent. This modulated signal is then received by the receiver coil, which demodulates the signal, extracting the original data from the modulated carrier wave. Typically, each of the first and second wireless communication units 22, 32 are equipped with one coil each. Power is typically transferred from the coil of the first communication unit 22 to the coil of the second communication unit 32. Data transfer is, however, bidirectional, meaning a coil can act as either a transmitter or receiver coil.

Data can also be transferred in both directions simultaneously, for example using Time Division Multiple Access (TDMA). This aims to prevent signal interference during simultaneous transmission and reception by allocating specific time slots for each unit to transmit and receive data, ensuring uninterrupted exchange of information.

The signal at the receiving coil (i.e., either one of 22 or 32) may undergo signal conditioning processes, such as amplification and filtering, to improve its quality and remove any noise. Subsequently, the demodulated data is processed and decoded to recover the original information.

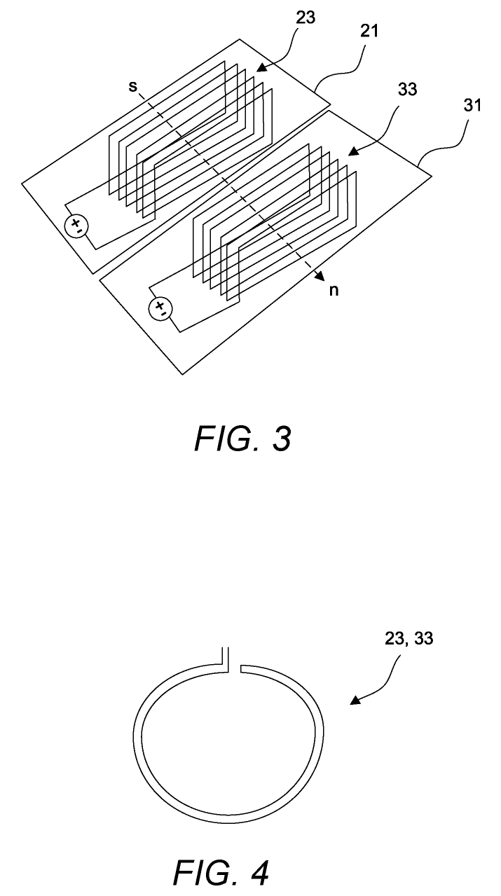

Factors such as data rate, which is influenced by coil design, distance between the units, and the chosen modulation technique, impacts the overall performance of this system. Hence, various different coil structures and alignment patterns can be realized. These are typically selected based on physical restrictions in the particular type of base module 20 and lever module 30, and how they fit with one another. In addition, the probability of successful message transfer diminishes with increased distance between coils or when smaller or less optimal coil designs are employed. The choice between coil structures and alignment patterns may also depend on desired efficiency and the nature of the electromagnetic interaction needed (e.g. how much power that needs to be supplied). For example, lever modules having fewer control buttons and/or functionality may not need to be powered to a high extent compared to other lever modules with a greater number of control buttons and/or functionality. Moreover, the modulation technique used also influence here, where lower data rates generally enhance the likelihood of successful transmission by providing more stable communication channels. Two exemplary coil structures and alignment patterns are shown in FIG. 3 and FIG. 4, respectively.

In FIG. 3, two coils 23, 33 are shown, one being arranged at a select portion 21 of the base module 20 and another at a select portion 31 of the lever module 30. As seen in the figure, the coils 23, 33 are aligned in a squared pattern. In the squared alignment, the sides of the coils 23, 33 align either parallel or perpendicular to each other, in this case parallel but the other option is viable as well. Squared coil alignments can improve coupling by focusing the magnetic field more directionally. This can enhance efficiency in specific configurations and allow for better integration in compact or angular spaces.

In FIG. 4, the coils 23, 33 are shown in a circular pattern. Here, the coils 23, 33 are laid on top of each other, and the figure shows this from a top view. The circular coil alignments may offer uniform magnetic fields and can be efficient for rotational symmetry, often resulting in smooth signal transmission and energy transfer. The circular pattern is typically easy to manufacture and align, providing consistent performance across various orientations.

While not shown, tube-like or cone-like alignment patterns can be envisaged in some cases as well. Tube-like coil alignments may be effective for applications requiring uniform magnetic fields along a cylindrical axis, and they may be useful for linear movements and can provide consistent coupling over longer distances. Cone-like coil alignments can focus the magnetic field in a more directed manner, which can enhance coupling efficiency in specific angles or tapered spaces. This design is useful when space constraints or specific directional requirements are present.

In either example, the coils should preferably overlap, regardless of rotational position. By way of example, rectangular coils are typically wrapped both inside and outside of a tube, ensuring that their surfaces align closely. This configuration improves the electromagnetic coupling by maintaining substantial overlap between the coils. By using rectangular shapes, the design ensures consistent performance even as the components rotate, leveraging the full potential of the available surface area for interaction.

In some examples, the coils 23, 33 may be integrated onto a circuit board, such as a Printed Circuit Board (PCB) or Flexible Printed Circuit (FPC). This integration allows for precise geometric control and compactness, making it suitable for applications where space is limited. It also enhances durability and stability by encapsulating the coils 23, 33 within the board material, reducing susceptibility to environmental factors.

In some examples, the coils 23, 33 may comprise Litz wires, employing multiple thin, insulated strands woven or twisted together. This design reduces energy losses due to skin effect and proximity effect at high frequencies, improving efficiency in power transfer and signal transmission. Litz wire coils may be advantageous in applications requiring high-frequency operation and reduced electromagnetic interference, for example in cases where the lever module 30 necessitates a higher power due to involving more complex functionalities.

In some examples, the coils 23, 33 may comprise discrete wires involve using one or more strands of wire to form the coils 23, 33. This approach allows for flexibility in coil design and configuration, accommodating various shapes and sizes.

Other exemplary RF technologies that can be envisaged, other than NFC, include Bluetooth, Qi, Wi-Fi Direct, Zigbee, Z-Wave, LoRa, UWB, LTE-M or Thread. In these other technologies, power may be provided in either direction between the first and second wireless communication units 32, 22. To this end,

Returning to FIGS. 1-2, the lever control system 10 is connected to the processing circuitry 12, or the processing circuitry 12 may form part of the lever control system 10. Specifically, the base module 20 is connected to the processing circuitry 12. By way of this connection, control actions carried out by the lever module 30 can be communicated using the wireless communication units 22, 32. For example, the lever module 30 may include one or more control buttons 34, which, when activated, trigger the second communication unit 32 to wirelessly transmit data to the processing circuitry 12 via the first communication unit 22.

Communication can also be realized the other way. The base module 20 can send various type of requests, such as a light indicator request, to the lever module 30, prompted by signals from the processing circuitry 12. This communication occurs through the wireless units 22, 32, enabling visual feedback or alerts on the lever module 30. Other requests from the processing circuitry 12 to the lever module 30, via the base module 20, may include throttle position requests, status requests, diagnostics requests, safety feature requests, and the like.

The above functionality can be enabled by way of arranging a control unit within the lever module 30 configured for handling inputs within the lever module 30. These inputs are received from the base module 20 and/or the control buttons 34. The control unit may include similar components as the processing circuitry 12 discussed above. The control unit is powered through power provisioning from the base module 20, enabled by the wireless communication units 22, 32. As such, the lever module 30 do not necessarily require a separate power supply, simplifying system design and maintenance while ensuring consistent operation.

Both the base module 20 and the lever module 30 may be designed with waterproof features, ensuring durability and reliability in marine environments. This can include waterproof housings, encasing the respective modules 20, 30 to protect against water ingress. Examples of waterproof features might include sealed enclosures (e.g. gaskets or O-rings), protective coatings applied to electronic components to shield them from moisture, or ingress protection-rated casings (utilizing materials and designs that meet specific ingress protection standards, ensuring resistance to water and dust).

In some examples, the lever module 30 may also include a separate battery for power supply, which can be rechargeable. Additionally, the lever module 30 can include a capacitor, either as an alternative or in conjunction with the battery, to provide additional power storage and efficient energy management. The battery and/or capacitor may act as an auxiliary power supply in cases where the lever module 30 may necessitate more power than what can be provided by the energy supply of the base module 20. The battery and/or capacitor provides additional power to the control unit arranged in the lever module 30.

The lever module 30 may further include a mechanical lock 36, as seen in FIG. 2. This lock 36 is to be engaged in order to be able to move the shaft 35 from its default position, ensuring that the lever remains securely in place during operation.

In further examples of this disclosure the following may be realized.

Example 1: A lever control system (10) for a marine vessel (1), comprising: a base module (20) comprising a first wireless communication unit (22); and a lever module (30) connected to the base module (20) and rotationally movable with respect to the base module (20), the lever module (30) comprising a second wireless communication unit (32), wherein the first and second wireless communication units (22, 32) are configured for bidirectional data communication, and wherein the first wireless communication unit (22) is configured to supply power to the lever module (30) via the second wireless communication unit (32).

Example 2: The lever control system (10) of example 1, wherein the wireless communication units (22, 32) comprise coils (23, 33) configured for radio frequency, RF, communication and power transfer.

Example 3: The lever control system (10) of example 2, wherein the coils (23, 33) are arranged at select portions (21, 31) of the base module (20) and the lever module (30), respectively, such that their respective axes align to allow intersection of generated magnetic fields in response to electrical current flow.

Example 4: The lever control system (10) of example 3, wherein the coils (23, 33) are aligned in a circular pattern.

Example 5: The lever control system (10) of example 3, wherein the coils (23, 33) are aligned in a squared pattern.

Example 6: The lever control system (10) of example 3, wherein the coils (23, 33) are aligned in a tube-like pattern.

Example 7: The lever control system (10) of example 3, wherein the coils (23, 33) are aligned in a cone-like pattern.

Example 8: The lever control system (10) of any of examples 2-7, wherein the coils (23, 33) are integrated onto a circuit board.

Example 9: The lever control system (10) of any of examples 2-7, wherein the coils (23, 33) comprise Litz wires.

Example 10: The lever control system (10) of any of examples 2-7, wherein the coils (23, 33) comprise discrete wires including one or more strands.

Example 11: The lever control system (10) of any of examples 2-10, the RF communication being based on a Near Field Communication (NFC) protocol.

Example 12: The lever control system (10) of any of examples 2-10, the RF communication being based on one a protocol including Bluetooth, Qi, Wi-Fi Direct, Zigbee, Z-Wave, LoRa, UWB, LTE-M, or Thread.

Example 13: The lever control system (10) of any preceding example, wherein the lever module (30) comprises one or both of a battery and a capacitor.

Example 14: The lever control system (10) of example 13, the battery being rechargeable.

Example 15: The lever control system (10) of any preceding example, wherein the lever module (30) is removably attached to a rotatable portion (20-1) of the base module (20).

Example 16: The lever control system (10) of example 15, wherein the removable attachment comprises one or more screws.

Example 17: The lever control system (10) of any preceding example, further comprising processing circuitry (12), the base module (20) being operatively connected to the processing circuitry (12).

Example 18: The lever control system (10) of example 17, wherein the lever module (30) includes one or more control buttons (34), wherein an activation of a control button (34) causes the second communication unit (32) to wirelessly communicate data to the processing circuitry (12) via the first communication unit (22).

Example 19: The lever control system (10) of example 18, wherein the base module (20) is configured to, in response to a signal from the processing circuitry (12) send a light indicator request to the lever module (30) via the wireless communication units (22, 32).

Example 20: The lever control system (10) of any preceding example, wherein each of the base module (20) and the lever module (30) comprise waterproof features.

The terminology used herein is for the purpose of describing particular aspects only and is not intended to be limiting of the disclosure. As used herein, the singular forms "a," "an," and "the" are intended to include the plural forms as well, unless the context clearly indicates otherwise. As used herein, the term "and/or" includes any and all combinations of one or more of the associated listed items. It will be further understood that the terms "comprises," "comprising," "includes," and/or "including" when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as "below" or "above" or "upper" or "lower" or "horizontal" or "vertical" may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being "connected" or "coupled" to another element, it can be directly connected or coupled to the other element, or intervening elements may be present. In contrast, when an element is referred to as being "directly connected" or "directly coupled" to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A lever control system for a marine vessel, comprising:
a base module comprising a first wireless communication unit; and
a lever module connected to the base module and rotationally movable with respect to the base module, the lever module comprising a second wireless communication unit,
wherein the first and second wireless communication units are configured for bidirectional data communication, and
wherein the first wireless communication unit is configured to supply power to the lever module via the second wireless communication unit.

2. The lever control system of claim 1, wherein the wireless communication units comprise coils configured for radio frequency, RF, communication and power transfer.

3. The lever control system of claim 2, wherein the coils are arranged at select portions of the base module and the lever module, respectively, such that their respective axes align to allow intersection of generated magnetic fields in response to electrical current flow.

4. The lever control system of claim 3, wherein the coils are aligned in a circular pattern.

5. The lever control system of claim 3, wherein the coils are aligned in a squared pattern.

6. The lever control system of claim 3, wherein the coils are aligned in a tube-like pattern.

7. The lever control system of claim 3, wherein the coils are aligned in a cone-like pattern.

8. The lever control system of claim 2, wherein the coils are integrated onto a circuit board.

9. The lever control system of claim 2, wherein the coils comprise Litz wires.

10. The lever control system of claim 2, wherein the coils comprise discrete wires including one or more strands.

11. The lever control system of claim 2, the RF communication being based on a Near Field Communication, NFC, protocol.

12. The lever control system of claim 2, the RF communication being based on one a protocol including Bluetooth, Qi, Wi-Fi Direct, Zigbee, Z-Wave, LoRa, UWB, LTE-M, or Thread.

13. The lever control system of claim 1, wherein the lever module comprises one or both of a battery and a capacitor.

14. The lever control system of claim 13, the battery being rechargeable.

15. The lever control system of claim 1, wherein the lever module is removably attached to a rotatable portion of the base module.

16. The lever control system of claim 15, wherein the removable attachment comprises one or more screws.

17. The lever control system of claim 1, further comprising processing circuitry, the base module being operatively connected to the processing circuitry.

18. The lever control system of claim 17, wherein the lever module includes one or more control buttons, wherein an activation of a control button causes the second communication unit to wirelessly communicate data to the processing circuitry via the first communication unit.

19. The lever control system of claim 18, wherein the base module is configured to, in response to a signal from the processing circuitry send a light indicator request to the lever module via the wireless communication units.

20. The lever control system of claim 1, wherein each of the base module and the lever module comprise waterproof features.
